(19) United States
(12) Patent Application Publication
(10) Pub. No.: US 2002/0152169 A1
(43) Pub. Date: Oct. 17, 2002

(54) Method and apparatus for facilitating transactions at an automatic teller machine

(76) Inventors: Rabindranath Dutta, Austin, TX (US); Dwip N. Banerjee, Austin, TX (US)

Correspondence Address: Duke W. Yee, Carstens, Yee & Cahoon, LLP, P.O. Box 802334, Dallas, TX, 75380, US

(21) Appl. No.: 09/833,339

(22) Filed: Apr. 12, 2001

(51) Int. Cl. G06F 17/60; G06K 19/02; G06K 7/10; G06K 9/20

(52) U.S. Cl. 705/45; 705/43; 705/39; 902/26; 382/321

(57) ABSTRACT

A method, apparatus and computer implemented instructions for processing checks in a data processing system. A customer check issued by a customer is received at the automatic teller machine. An amount for the customer check is identified. A new check for the amount is created in which the funds for the amount are guaranteed by a financial institution.

### CROSS REFERENCE TO RELATED APPLICATIONS

The present invention is related to the following applications: Method and Apparatus for Processing Checks at an Automatic Teller Machine for Electronic Transfer, Ser. No. ______, attorney docket no. AUS920010211US1; Method and Apparatus for Processing a Check within a Financial System, Ser. No. ______, attorney docket no. AUS920010213US1; Method and Apparatus for Incorporating Scanned Checks into Financial Applications, Ser. No. ______, attorney docket no. AUS920010214US1; and Method and Apparatus for Bill Payments at an Automatic Teller Machine, Ser. No. ______, attorney docket no. AUS9200102015US1.

### BACKGROUND OF THE INVENTION

1. Technical Field

The present invention relates generally to an improved data processing system and in particular to a method and apparatus for providing financial services in a data processing system. Still more particularly, the present invention provides a method and apparatus for providing security in transactions at an automatic teller machine.

2. Description of Related Art

Automatic teller machines (ATMS) are widely available devices used for dispensing cash. An ATM user is provided with an ATM card as well as a personal identification number (PIN) or password for use in withdrawing funds. Typically, the ATM user withdraws cash from a checking account, a savings account, or as an advance from a credit card. A user also may use an ATM to transfer money from a savings account to a checking account. In other instances the user uses the ATM to ascertain an account balance for a checking account or savings account.

Other uses have been added to ATMs in addition to dispensing cash. For example, some ATMs now provide a feature in which stamps are dispensed to the user rather than cash. Another use is an ability to deposit cash or checks through an ATM. A user places cash or a check in an envelope provided at the ATM. Next, the user places the ATM card into the ATM, enters a PIN number, and selects an option to make a deposit. The user then enters the amount being deposited and places the envelope into the ATM. Deposits are then later collected and processed. ATMs are widely used because they provide convenient services that are often not available at a business location of a financial institution. For example, at an ATM a user may obtain cash 24 hours a day. Although these types of ATM services are becoming more widespread and easy to access, the variety in types of services provided by an ATM are still limited.

Therefore, it would be advantageous to have an improved method and apparatus for providing additional services at an ATM.

### SUMMARY OF THE INVENTION

The present invention provides a method, apparatus and computer implemented instructions for processing checks in a data processing system. A customer check issued by a customer is received at the automatic teller machine. An amount for the customer check is identified. A new check for the amount is created in which the funds for the amount are guaranteed by a financial institution.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a diagram of a client in the form of a personal digital assistant (PDA) in accordance with a preferred embodiment of the present invention;

FIG. 4 is a block diagram of a PDA in accordance with a preferred embodiment of the present invention;

FIG. 5 is a diagram illustrating an automatic teller machine (ATM) in accordance with a preferred embodiment of the present invention;

FIG. 6 is a block diagram illustrating an ATM in accordance with a preferred embodiment of the present invention;

FIG. 7 is a diagram illustrating transfer of information for import into a financial application in accordance with a preferred embodiment of the present invention;

FIG. 8 is a diagram illustrating data flow in creating a check image in accordance with a preferred embodiment of the present invention;

FIG. 9 is a diagram of a smart card, which may be used to create an electronic check, in accordance with a preferred embodiment of the present invention;

FIG. 10 is a diagram of a check presented on a display for completion in accordance with a preferred embodiment of the present invention;

FIG. 11 is a diagram illustrating software components in an ATM in accordance with a preferred embodiment of the present invention;

FIG. 12 is an illustration of a message sent from an ATM to a financial institution in accordance with a preferred embodiment of the present invention;

FIG. 13 is a flowchart of a process used for creating an electronic check in an ATM in accordance with a preferred embodiment of the present invention;

FIG. 14 is a flowchart of a process used for creating an electronic check in accordance with a preferred embodiment of the present invention;

FIG. 15 is a flowchart of a process used for processing a check deposited at an ATM in accordance with a preferred embodiment of the present invention;

FIG. 16 is a flowchart of a process used for incorporating checks into a financial system;

FIG. 17, a flowchart of a process used for depositing a check in accordance with a preferred embodiment of the present invention;

FIG. 18 is a flowchart of a process used for generating a certified check in accordance with a preferred embodiment of the present invention;

FIG. 19 is a flowchart of a process used for authenticating a check in accordance with a preferred embodiment of the present invention;

FIGS. 20A-20C are diagrams illustrating a digital watermark in accordance with a preferred embodiments of the present invention; and

FIG. 21 is a flowchart of a process used for providing a user identification document in accordance with a preferred embodiment of the present invention.

### DETAILED DESCRIPTION OF THE PREFERRED EMBODIMENT

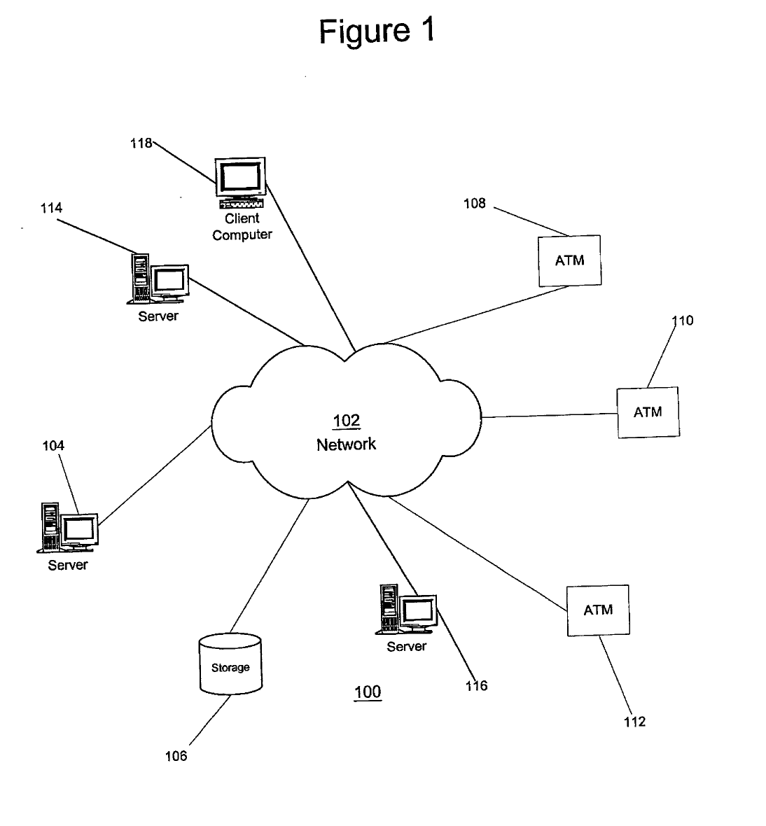

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. Server 104 is a computer located at a financial institution, such as a bank, a credit union, a mortgage company, or a brokerage firm.

Server 104 is used to provide various functions relating to daily financial transactions handled by the bank, such as deposits and withdrawals of funds. In addition, ATMs 108, 110, and 112 also are connected to network 102. ATMs 108, 110, and 112 are clients to server 104. Server 104 is in communication with ATMs 108, 110, and 112 to handle various transactions that users may initiate at these devices. For example, if a user withdraws cash from ATM 108, the debiting of the account is handled by server 104.

Server 114 and server 116 also are connected to network 102 and may represent computers located at other financial institutions. ATMs 108, 110, and 112 also may be clients to these servers depending on the particular user accessing ATMs 108, 110 and 112. Additionally, these servers may also represents computers located at other financial institutions, such as a regional clearing house, a national clearing house, or a Federal Reserve Bank.

The present invention provides for scanning of checks at an ATM, such as ATM 108, when a user deposits a check with the financial institution. An image of both sides of the check is made when the check is deposited. Additionally, optical character recognition is performed on the check to obtain information, such as the recipient of the check, and the amount of funds to be transferred from the account. Further, a magnetic ink reader reads magnetic ink data on the check to obtain information, such as the bank's identification number as well as the user's checking account number with the bank. A markup language document is created containing this other information obtained from the check. The markup language document forms an electronic check. Additionally, the image of the check also may be associated with the markup language document as part of the electronic check. This electronic check is then sent from ATM 108 to server 104 for processing. Additionally, the present invention also provides other services, such as converting a regular check to a certified check and issuing temporary identification documents.

Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

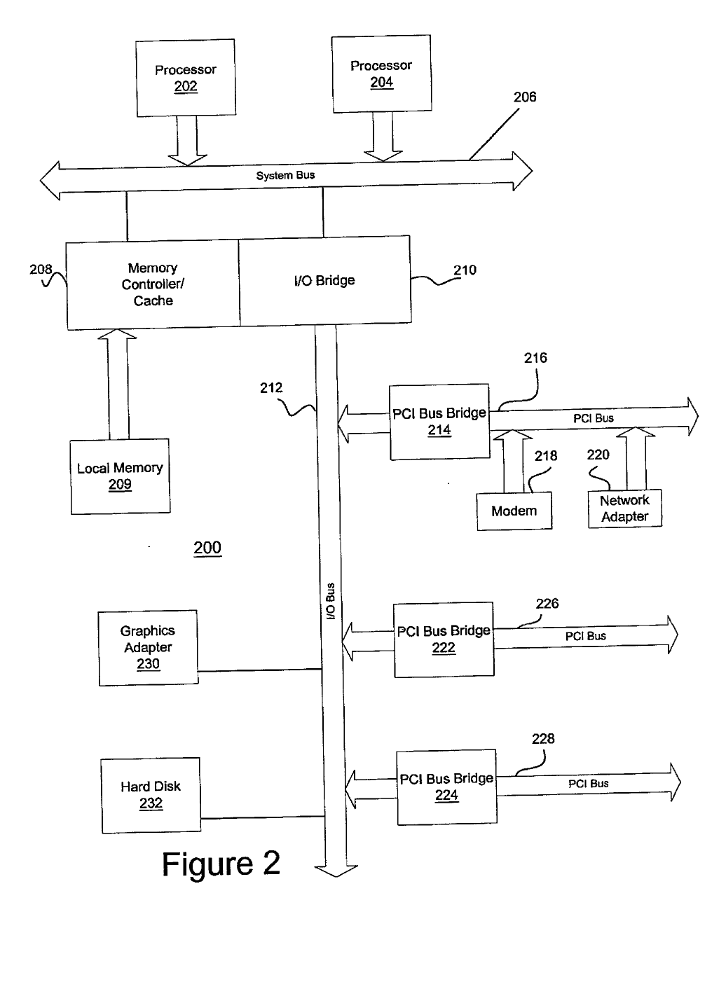

Referring to FIG. 2, a block diagram of a data processing system that may be implemented as a server, such as server 104, 114, or 116 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to ATMs 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

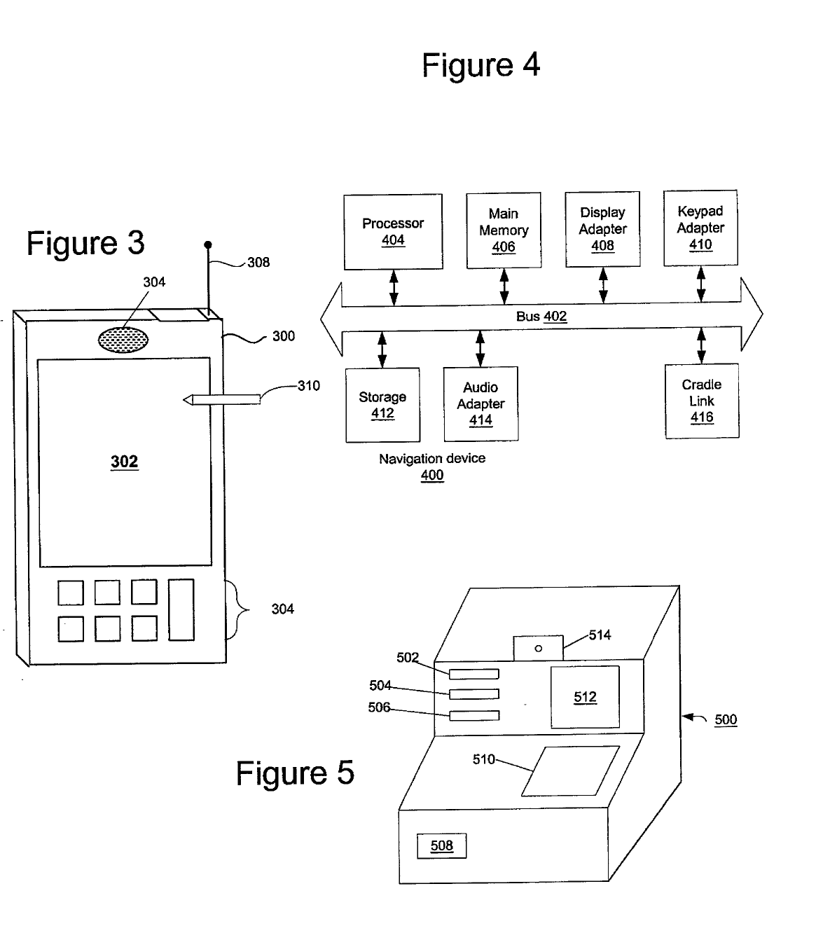

With reference now to FIG. 3, a diagram of a client in the form of a personal digital assistant (PDA) is depicted in accordance with a preferred embodiment of the present invention. PDA 300 includes a display 302 for presenting textual and graphical information. Display 302 may be a known display device, such as a liquid crystal display (LCD) device. The display may be used to present a map or directions, calendar information, a telephone directory, or an electronic mail message. In these examples, display 302 may receive user input using an input device such as, for example, stylus 310.

PDA 300 may also include keypad 304, speaker 306, and antenna 308. Keypad 304 may be used to receive user input in addition to using display 302. Speaker 306 provides a mechanism for audio output, such as presentation of an audio file. Antenna 308 provides a mechanism used in establishing a wireless communications link between PDA 300 and a network, such as network 102 in FIG. 1.

PDA 300 also preferably includes a graphical user interface that may be implemented by means of systems software residing in computer readable media in operation within PDA 300.

Turning now to FIG. 4, a block diagram of a PDA is shown in accordance with a preferred embodiment of the present invention. PDA 400 is an example of a PDA, such as PDA 300 in FIG. 3, in which code or instructions implementing the processes of the present invention may be located. PDA 400 includes a bus 402 to which processor 404 and main memory 406 are connected. Display adapter 408, keypad adapter 410, storage 412, and audio adapter 414 also are connected to bus 402. Cradle link 416 provides a mechanism to connect PDA 400 to a cradle used in synchronizing data in PDA 400 with another data processing system. Further, display adapter 408 also includes a mechanism to receive user input from a stylus when a touch screen display is employed.

An operating system runs on processor 404 and is used to coordinate and provide control of various components within PDA 400 in FIG. 4. The operating system may be, for example, a commercially available operating system such as Windows CE, which is available from Microsoft Corporation. Instructions for the operating system and applications or programs are located on storage devices, such as storage 412, and may be loaded into main memory 406 for execution by processor 404.

Those of ordinary skill in the art will appreciate that the hardware in FIG. 4 may vary depending on the implementation. Other internal hardware or peripheral devices, such as flash ROM (or equivalent nonvolatile memory) or optical disk drives and the like, may be used in addition to or in place of the hardware depicted in FIG. 4.

Turning next to FIG. 5, a diagram illustrating an automatic teller machine (ATM) is depicted in accordance with a preferred embodiment of the present invention. ATM 500 is an illustration of an ATM, such as ATM 108, 110 or 112 in FIG. 1.

In this example, an ATM card or a smart card may be received in slot 502. ATM 500 also includes an input slot 504 and an output slot 506. Input slot 504 is used to receive items, such as cash or a check for deposit. Cash dispenser slot 508 is used to dispense cash to a user. Keypad 510 provides an input device for a user to input information, such as an amount of money that is to be deposited or to make selections, such as receiving an account balance or an amount of cash to withdraw. Display 512 is used to present information to the user. Video camera 514 provides for recording transactions. Additionally, video camera 514 may be used to capture an image of the user at ATM 500.

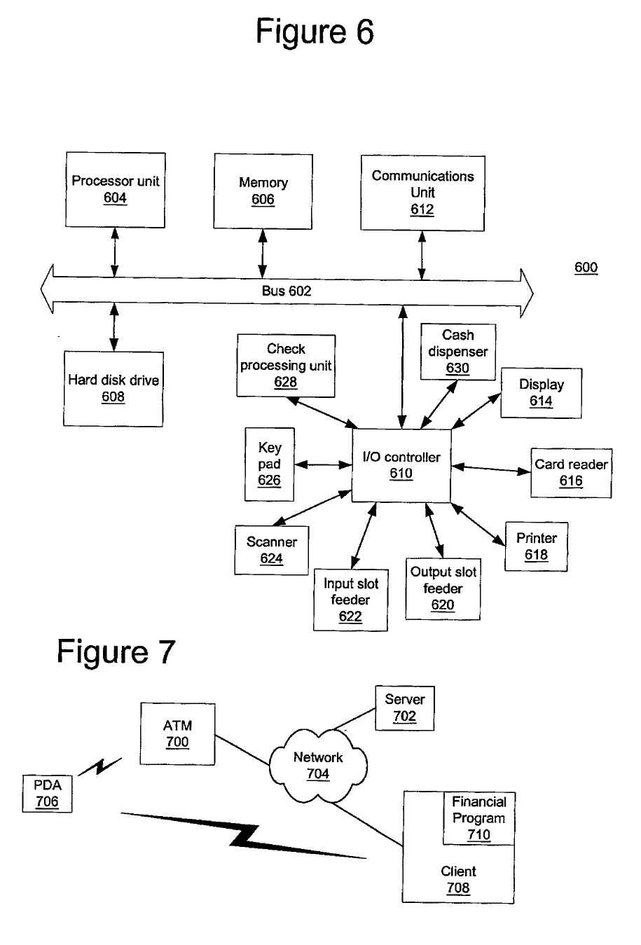

Turning next to FIG. 6, a block diagram illustrating an ATM is depicted in accordance with a preferred embodiment of the present invention. ATM 600 may be implemented as in ATM 108, 110, or 112 in FIG. 1.

In the depicted examples, bus 602 connects processor unit 604, memory 606, hard disk drive 608, I/O controller 610, and communications unit 612. Computer instructions may be located in memory 606 or in hard disk drive 608. These instructions are processed by processor unit 604 to provide ATM functions as well as the check scanning and electronic check creation processes of the present invention. Additionally, transaction information may also be stored on hard disk drive 608. Communications unit 612 establishes a communications link with a server, such as server 104, 114 or 116 in FIG. 1 through a network, such as network 102 in FIG. 1. I/O controller 610 provides a mechanism for input/output devices, such as, for example, display 614, card reader 616, printer 618, output slot feeder 620, input slot feeder 622, scanner 624, keypad 626, check processing unit 628, and cash dispenser 630. Display 614 provides a mechanism to present information to the ATM user. Card reader 616 is used to read an ATM card or a smart card inserted into the ATM. Printer 618 is used to print a receipt or other information in response to a user input. Keypad 626 is used to receive user input. Output slot feeder 620 is used to feed receipts generated by printer 618 to an output slot, such as output slot 506 in FIG. 5. Input slot feeder 622 is used to receive checks or cash placed into an input slot, such as input slot 504 in FIG. 5. Check processing unit 628 is used to move a check within the ATM. In particular, check processing unit 628 may move a check into a position for scanning by scanner 624 and then move the check into storage. If a check in not accepted, the check may be returned to output slot feeder 620 for return to a user. Cash dispenser 630 is used to dispense cash when a user withdrawals funds from a user account.

The components depicted in FIGS. 3 and 6 are provides for purposes of illustration and are not meant to imply architectural limitations to the present invention.

With reference now to FIG. 7, a diagram illustrating transfer of information for import into a financial application is depicted in accordance with a preferred embodiment of the present invention. A user may deposit a check at ATM 700 for credit to the user's account with a financial institution. In these examples, the check is scanned within ATM 700 to create an image of the check. This check and information obtained from the check may be sent to server 702 located at the financial institution through network 704. Information regarding the deposit of the check may be returned to ATM 700 from server 702. This information as well as an image of the check may be downloaded to the user through a mobile devise, such as PDA 706. PDA 706 is shown for purposes of illustration and other mobile devices, such as a mobile phone, also may be used. In the depicted examples, the information is placed into a format that may be imported by various financial programs. The user may then upload the information to client 708 for import to financial program 710. In this manner, check images and other financial information may be easily integrated into financial programs or applications. Financial programs also could be located in PDA 706 depending on the implementation.

Additionally, the check image and other financial information may be sent or made available to a user through a Web site or sending of an e-mail. For example, the check image and information may be placed into a file in a format for import to a financial program on a secure Web site. The user accesses the Web site through client 708 by entering an appropriate ID and password. The user may then download the file for import and use in the financial program. The transfer takes place using a secure connection, such as that provided by the Secure Sockets Layer (SSL) protocol. Alternatively, the information may be sent in an e-mail or as an attachment to an e-mail in an encrypted form.

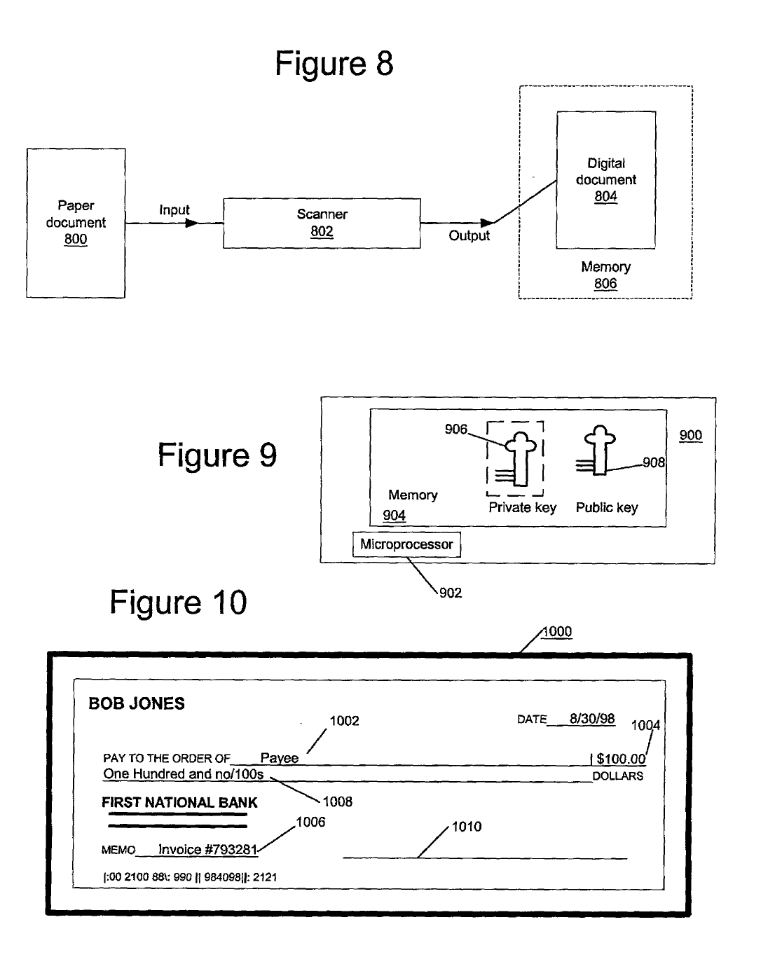

Turning next to FIG. 8, a diagram illustrating data flow in creating a check image is depicted in accordance with a preferred embodiment of the present invention. Paper document 800 is input or placed into an ATM, such as ATM 500 through input slot 504 in FIG. 5. In this example, paper document 800 is a check. Scanner 802 scans both sides of paper document 800. In this manner, endorsements as well as signature and amount information from the front of the check may be obtained. Digital document 804 is generated by scanner 802 and stored in memory 806 for further processing. Optical character recognition processes (OCR) may be initiated to process digital document 804 to generate information used to in creating a markup language representation of paper document 800. In these examples, this markup language representation forms an electronic check. With reference now to FIG. 9, a diagram of a smart card, which may be used to create an electronic check, is depicted in accordance with a preferred embodiment of the present invention. Smart card 900 is a credit card with microprocessor 902 and memory 904, and is used for identification of financial transactions. When inserted into a reader, through slot 502 in ATM 500 in FIG. 5, smart card 900 transfers data to and from ATM 500. In these examples, smart card 900 contains private key 906 and public key 908 within memory 904. These keys are used for digital signing of checks in these examples.

More precisely, the private key is used in the process of applying a digital signature to an electronic check or an electronic document. Applying a digital signature by using hashing operations in a private key is well known to those of ordinary skill in the art. However, for other activities the public key of an individual is also typically stored in a smart card and this is how smart card 900 has been depicted. Note that smart card 900 is depicted for the purposes of the preferred embodiment of the present invention. Other cards, such as credit cards may also be used. Popular usage does not normally refer to credit cards as smart cards. However, technically speaking even credit cards are a type of smart card and are governed by internationally accepted appropriate smart card standards. Hence, the preferred embodiment of the present invention is illustrated through a generic smart card in preference to a conventional credit card or an ATM card.

Smart card 900 is more secure than a magnetic stripe card and can be programmed to self-destruct if the wrong password is entered too many times. As a financial transaction card, smart card 900 can be loaded with digital money and used like a travelers check, except that variable amounts of money can be spent until the balance is zero.

Turning now to FIG. 10, a diagram of a check presented on a display for completion is depicted in accordance with a preferred embodiment of the present invention. Check 1000 is an example of a check, which may be presented to a user on a display, such as display 512 in ATM 500 in FIG. 5. Check 1000 is presented to the user after verification of the user's authority to generate a check. In the depicted examples, the verification is made by an insertion of a smart card in an ATM, such as ATM 500 in FIG. 5 along with entry of a correct password or PIN. The user may enter information into payee field 1002, amount field 1004 and memo field 1006. Entry of an amount in amount field 1004 results in amount field 1008 being auto filled for the user. In this example, payee field 1002 and amount field 1004 are required fields that must be filled in for check 1000 to be complete. Memo field 1006 is an optional field, which may be left blank. In the depicted examples, a digital signature is used to complete the check and may be provided through the smart card. Depending on the implementation, the user may actually sign field 1010 using a stylus if the display includes a touch screen to accept such data.

When the user affirms that the check is complete and should be sent, the check may then be routed to the payee or to some other party in the form of an electronic check. The electronic check is in the form of a markup language document as described above. More specifically, financial services markup language (FSML) is an example of a markup language, which may be used to generate electronic checks.

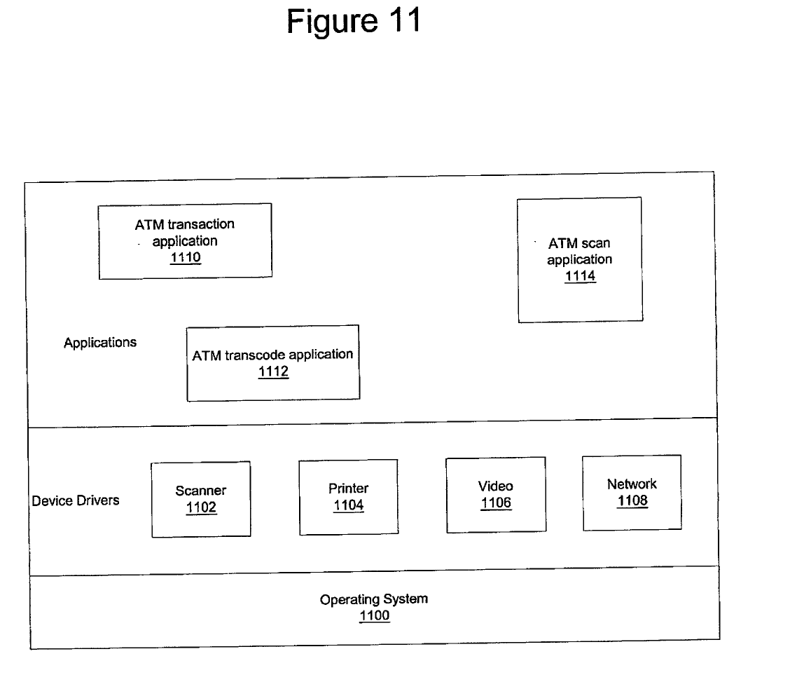

Turning next to FIG. 11, a diagram illustrating software components in an ATM is depicted in accordance with a preferred embodiment of the present invention. In this example, the software components in an ATM include operating system 1100, scanner device driver 1102, printer device driver 1104, video device driver 1106, network device driver 1108, ATM transaction application 1110, ATM transcode application 1112, and ATM scan application 1114.

The device drivers provide the components needed to operate devices within an ATM. These device drivers are used by ATM transaction application 1110, ATM transcode application 1112, and ATM scan application 1114 to perform various input/output functions.

ATM transaction application 1110 provides a process for various transactions by a user. Cash withdrawals, balance inquiries, fund transfers, and deposits are examples of transactions that may be handled through ATM transaction application 1110. Additionally, ATM transaction application 1110 handles the transmission and receipt of information to and from various financial institutions. When a check is deposited, ATM scan application 1114 is initiated to create an image of the check. In the depicted examples, the image is of both sides of the check. Additionally, ATM scan application 1114 also will include optical character recognition (OCR) processes to obtain data for use in creating an electronic check. This data is used by ATM transcode application 1112 to generate a markup language representation of the check.

ATM transaction application 1110 also may transfer the image of a check and other information to a user mobile device, such as a PDA or mobile phone. The user may then upload that information to a computer containing a financial program. The image and information is placed into a format that allows for its import into the financial program.

In these examples, the markup language may be financial services markup language (FSML) and signed document markup language (SDML). FSML is used to implement electronic checks and other secure financial documents. FSML defines a method to structure documents into blocks of tagged content. Unlike HTML, which uses tags to inform processors about how to display content, FSML uses tags to inform processors about how to use the document content in financial applications. The FSML content blocks in an FSML document can be cryptographically sealed and signed in any combination needed by business applications. Document processors may also remove blocks without invalidating the signatures on the remaining blocks. They may combine signed documents and then sign blocks contained in the combined documents. Signatures are themselves structured as FSML blocks, as are the X.509 certificates needed by downstream processors to verify the signatures. Thus signatures and certificates become part of the FSML document, so they can be verified and countersigned by later signers.

SDML is designed to tag the individual text items making up a document, group the text items into document parts which can have business meaning and can be signed individually or together, allow document parts to be added and deleted without invalidating previous signatures, and allow signing, cosigning, endorsing, co-endorsing, and witnessing operations on documents and document parts. The signatures become part of the SDML document and can be verified by subsequent recipients as the document travels through the business process. SDML does not define encryption, since encryption is between each sender and receiver in the business process and can differ for each link depending on the transport used. SDML is the generic document structuring and signing part of the FSML.

In the depicted examples, the markup language document forms an electronic check. Depending on the implementation, the electronic check also may include the image of the check.

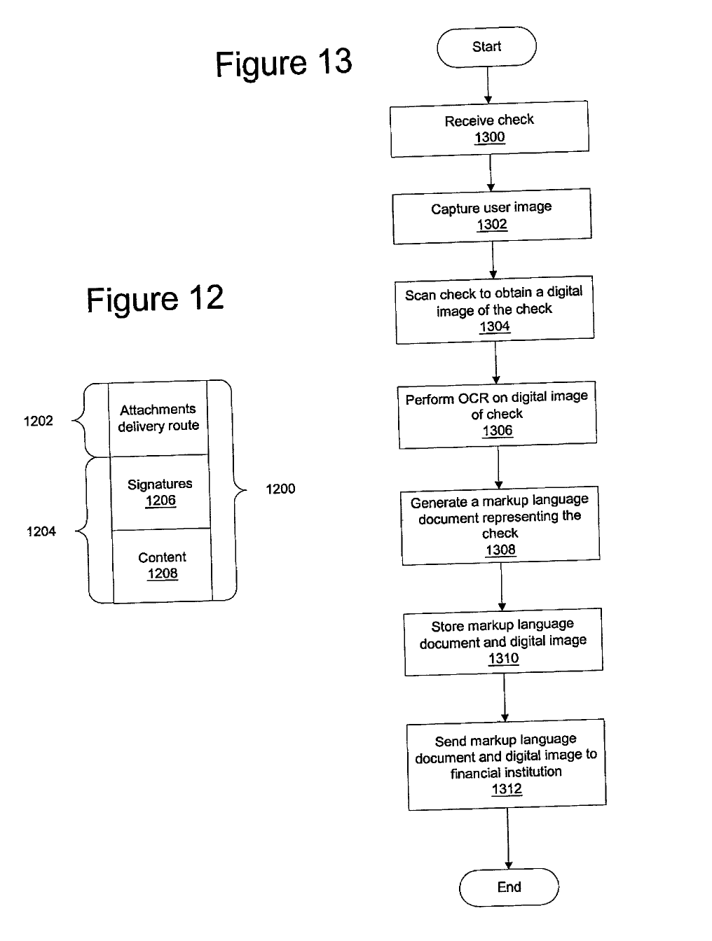

Turning next to FIG. 12 an illustration of a message sent from an ATM to a financial institution is depicted in accordance with a preferred embodiment of the present invention. Message 1200 is an example of a message that may be sent from an ATM to a financial institution. For example, an electronic check generated at an ATM, such as ATM 108 in server 104 in FIG. 1 for processing. The electronic check may be sent within message 1200.

Message 1200 includes header 1202 and body 1204. Header 1202 may include information, such as an identification of attachments and a delivery route for the message. Body 1204 may include signatures 1206 as well as content 1208. Signatures 1206 may be obtained from scanning of the check or via a digital signature from a smart card held by the user. Content 1208 may contain the digital image of the check and/or an electronic check. The electronic check may be a document created using FSML and SDML.

Turning next to FIG. 13, a flowchart of a process used for creating an electronic check in an ATM is depicted in accordance with a preferred embodiment of the present invention. The process illustrated in FIG. 13 may be implemented within ATM scan application 1114 and ATM transcode application 1112 in FIG. 11.

The process begins by receiving a check (step 1300). An image of the user is captured (step 1302). Next, the check is scanned to obtain a digital image of the check (step 1304). In these examples, both sides of the check are scanned. Additionally, this scanning step also may include reading magnetic ink data on the check, which may contain a bank identification number and a checking account number. Optical character recognition (OCR) is performed on the digital image of the check to generate data for use in creating an electronic check (step 1306).

Then, a markup language document is generated representing the check (step 1308). This markup language document forms an electronic check in this example. The markup language document and digital image are stored (step 1310). Thereafter, the markup language document and the digital image are sent to the financial institution (step 1312) with the process terminating thereafter. The markup language document and digital image are sent to the financial institution through a communications link, such as one provided by network 102 in FIG. 1.

In this manner, the check deposited by the ATM user can be processed without requiring further physical handling to transfer funds to the ATM user's account. Thus, the process used for transferring funds between account may be streamlined through the creation of electronic checks from physical checks at an ATM.

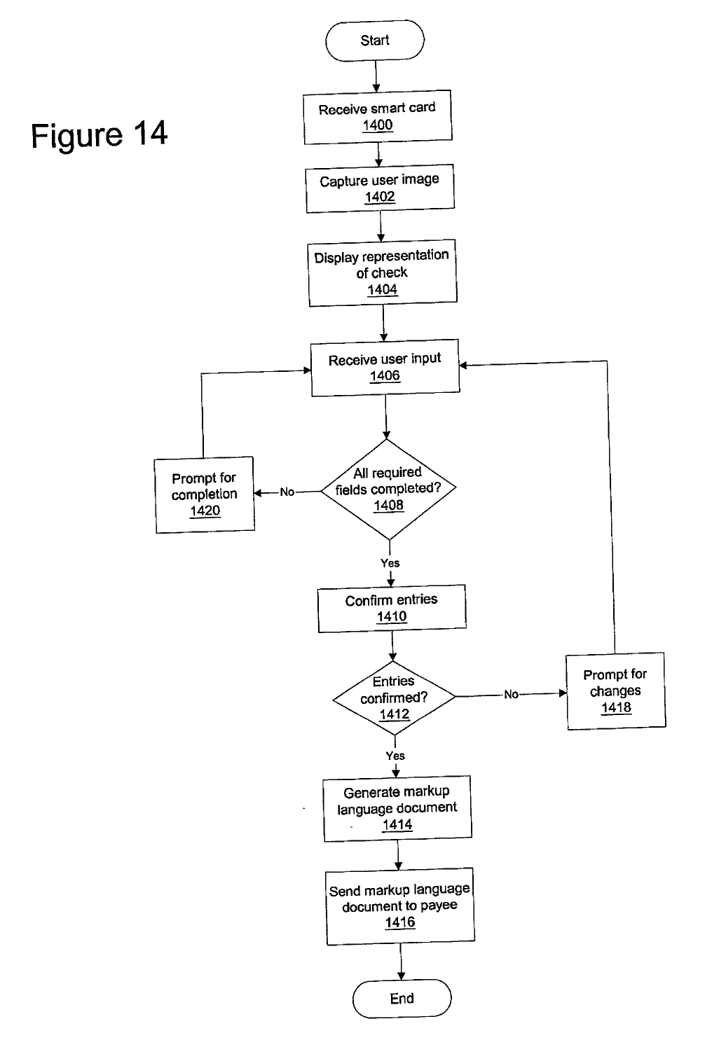

Turning next to FIG. 14, a flowchart of a process used for creating an electronic check is depicted in accordance with a preferred embodiment of the present invention. The process illustrated in FIG. 14 may be implemented in a set of computer instructions for use in applications, such as ATM transaction application 1110 and ATM transcode application 1112 in FIG. 11.

The process begins by receiving a smart card, such as smart card 900 in FIG. 9 from a user (step 1400). The user image is then captured (step 1402). Next, a representation of a check, such as check 1000 in FIG. 10 is displayed (step 1404). The user is the payor in this example. User input is then received (step 1406). This user input includes entry of information into fields, such as an amount for the check, a payee, and a memo. A determination is then made as to whether all required fields are completed (step 1408).

If all required fields are completed, the entries are confirmed (step 1410). This confirmation allows the user one last chance to make changes or cancel the check before the transaction is initiated. Next, a determination is then made as to whether the entries are confirmed (step 1412). If confirmed, a markup language document is generated (step 1414). This document forms the electronic check. The markup language document is then sent to the payee, the payee's financial institution, or some third party authorized to receive checks for the payee (step 1416) with the process terminating thereafter.

With reference again to step 1412, if the entries are not confirmed, the user is prompted for changes (step 1418) and the process returns to step 1406 as described above. Turning back to step 1408, if all required fields are not completed, then the user is prompted for completion (step 1420) and the process returns to step 1406.

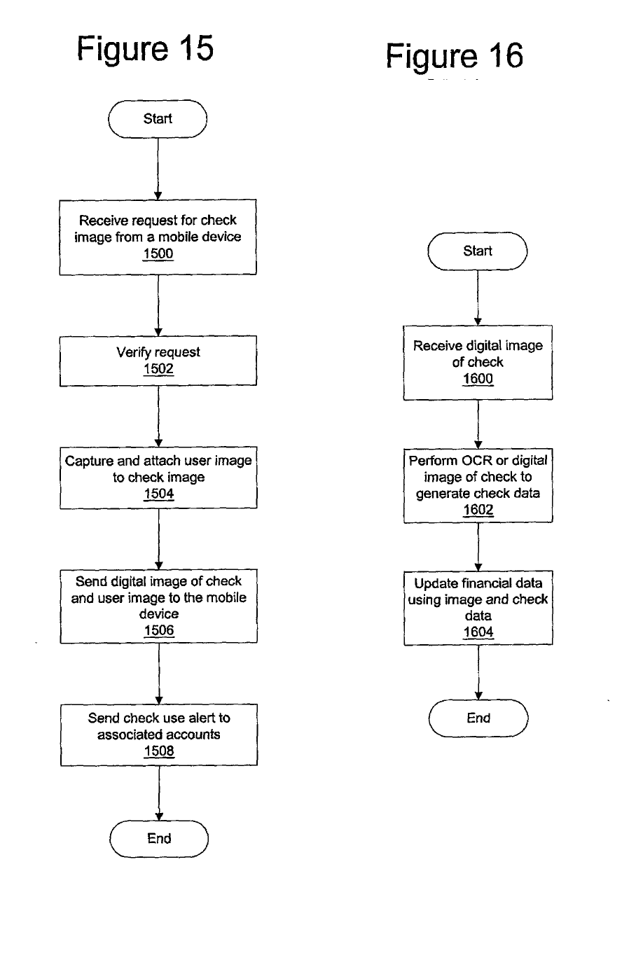

Referring to FIG. 15, a flowchart of a process used for processing a check deposited at an ATM is depicted in accordance with a preferred embodiment of the present invention. The process illustrated in FIG. 15 may be implemented in an ATM, such as ATM 600 in FIG. 6. The processes illustrated in FIG. 15 may be applied to checks deposited by a user as well as checks issued to the user.

The process begins by receiving a request for a check image from a mobile device (step 1500). The request is verified (step 1502). This verification step is employed to ensure that the mobile device is authorized to receive the image. This verification may be made through various mechanisms. For example, a certificate system may be employed to verify the request. The user image is captured and attached to the check image (step 1504). This user image may be used to identify the user issuing a check or depositing a check in the case of multi-user accounts. Next, the digital image of the check and user image are sent to the mobile device (step 1506). This information may be compressed to save storage space within the mobile device. This information is now available for further use, such as importing the information into a financial program.

A check use alert is then sent to all associated accounts (step 1508) with the process terminating thereafter. This alert allows all users of an account to be aware of when a check is issued or deposited. The alert may, for example, include the check image as well as any debit or credit information. In this manner, all users of an account will be able to quickly identify the current amount of funds present within the account.

Turning now to FIG. 16, a flowchart of a process used for incorporating checks into a financial program. The process illustrated in FIG. 16 may be implemented in a financial program, such as financial program 710 in FIG. 7. The images may be received in a format that is suitable for importation into the financial program. For example, the format may be an image associated with a particular type of file recognized by the financial program. Alternatively, the image may merely be in a common format, such as a *.tif or a *.jpg format, which may be used directly by the financial program.

The process begins by receiving a digital image of the check (step 1600). Optical character recognition (OCR) is them performed on the digital image of the check to generate check data (step 1602). Next, financial data is updated using the image and the check data (step 1604) with the process terminating thereafter.

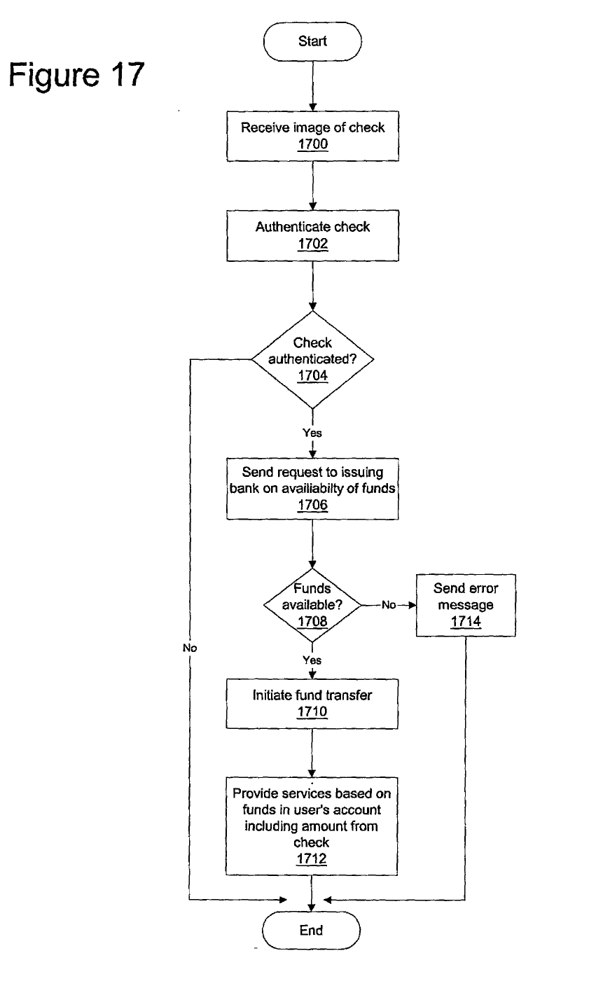

Referring now to FIG. 17, a flowchart of a process used for depositing a check is depicted in accordance with a preferred embodiment of the present invention. The process illustrated in FIG. 17 may be implemented in a program, such as ATM transaction application 1110 in FIG. 11. The advent of high quality scanners, printers, and computers has resulted in an increased occurrence of fake checks. The mechanism of the present invention provides for issuing checks with a digital watermark. Fraudulent checks will not include this watermark. When a check is deposited, the check is scanned for this watermark using a verification process.

The process in FIG. 17 begins by receiving an image of a check (step 1700). The image is one generated by a scanner, such as scanner 624 within ATM 600 in FIG. 6. Next, the check is authenticated (step 1702). This authentication process may include verifying signatures in the image as well as determining whether the appropriate digital watermark is present in the image.

A determination is then made as to whether the check has been authenticated (step 1704). If the check is authenticated, a request to the issuing bank is sent to confirm the availability of funds (step 1706). Then, a determination is made as to whether the user has available funds (step 1708). If funds are available, a fund transfer is initiated (step 1710). Services are provided based on funds in the user's account, including the amount from the check (step 1712) with the process terminating thereafter. These services may include, for example, dispensing cash, paying bills, generating a new check, or generating a certified check. As used herein, a certified check is a check that is backed by a trusted business or the government, instead of a private individual's bank account.

Turning back to step 1708, if funds are not available, an error message is presented to the user (step 1714) with the processing terminating thereafter. For example, the error message may tell the user that insufficient funds are present in the account to cover the check and to retry depositing the check at a later time. With reference again to step 1704, if the check is not authenticated, the process terminates.

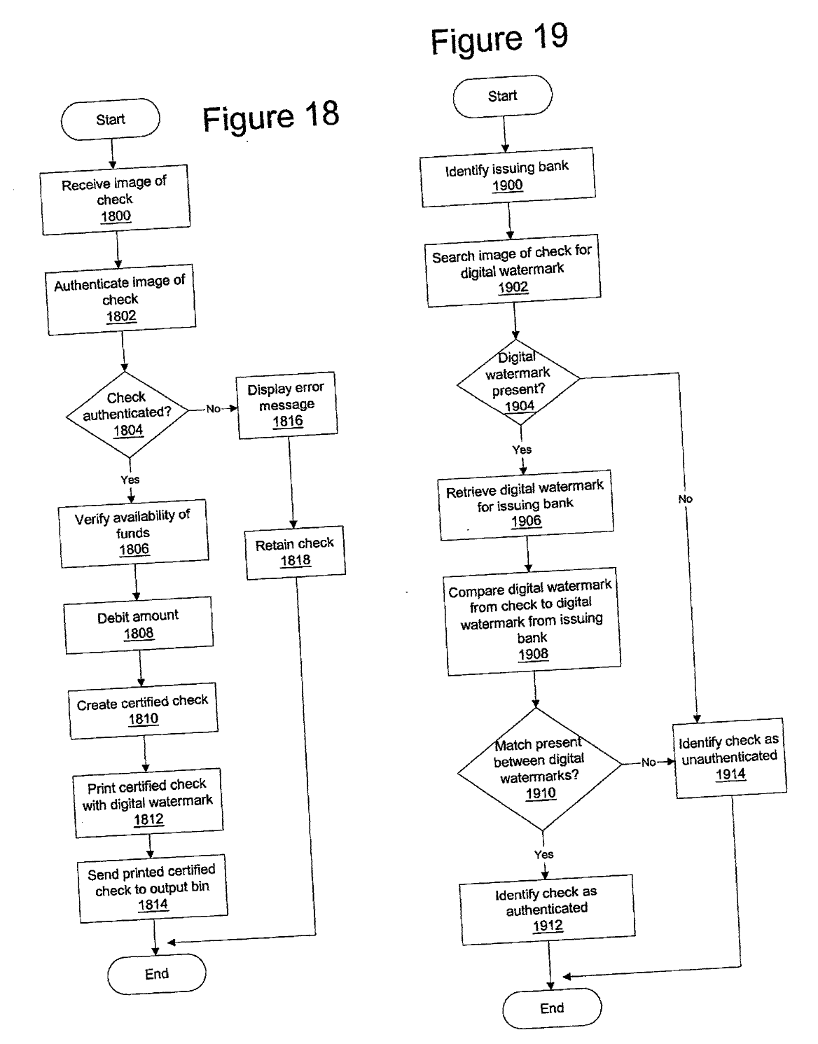

Turning next to FIG. 18, a flowchart of a process used for generating a certified check is depicted in accordance with a preferred embodiment of the present invention. The process illustrated in FIG. 18 may be implemented in a program, such as ATM transaction application 1110 in FIG. 11.

The process begins by receiving am image of a check (step 1800). The image is for the check scanned by scanner within the ATM in these examples. This check may be a check issued to the user from another account or a check issued by the user from the user's account. The image of the check is authenticated (step 1802). This authentication may include verification of signatures and verification of digital watermarks in the image.

A determination is then made as to whether the check has been authenticated (step 1804). If the check has been authenticated, the availability of funds is verified (step 1806). The account is debited (step 1808) and a certified check is created (step 1810). The certified check is then printed with a digital watermark (step 1812). This digital watermark is uniquely associated with the financial institution and is used to verify that the check is a valid check. Next, the printed certified check is sent to an output bin, such as cash dispenser slot 508 in FIG. 5 (step 1814) with the process terminating thereafter.

Returning to step 1802, if the check is not authenticated, an error message is displayed (step 1116). Then, the check is retained (step 1818) with the process terminating thereafter.

Turning now to FIG. 19, a flowchart of a process used for authenticating a check is depicted in accordance with a preferred embodiment of the present invention. The process illustrated in FIG. 19 may be implemented in a program, such as ATM transaction application 1110 in FIG. 11.

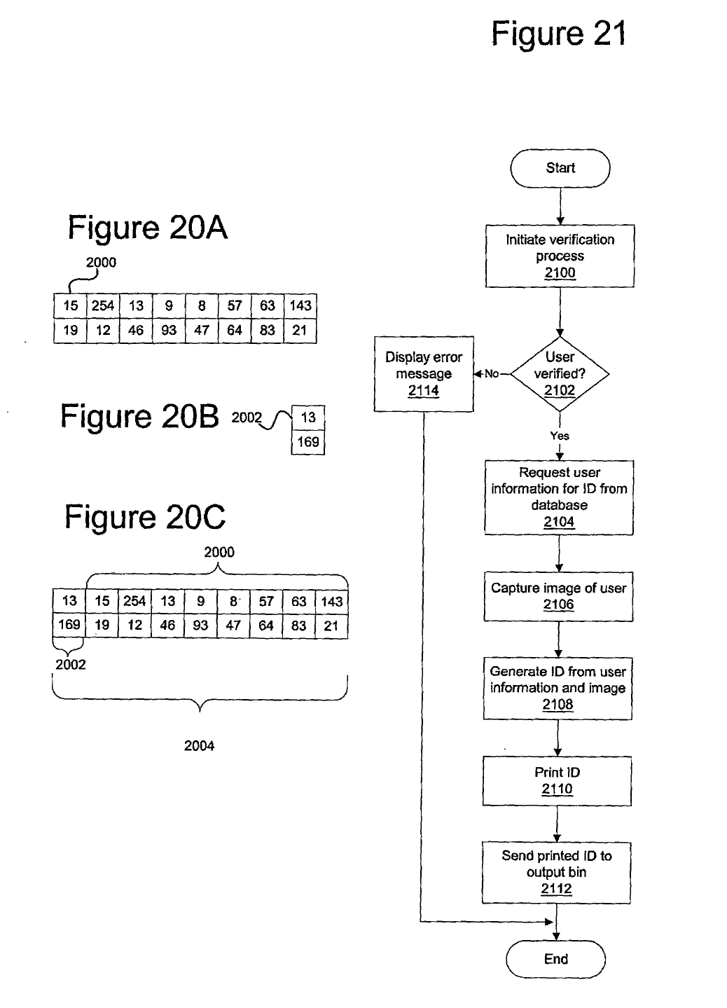

The process begins by identifying an issuing bank (step 1900). This identification may be made by performing OCR on the image to obtain routing information to identify the financial institution. The image of the check is searched for a digital watermark (step 1902). Digital watermarks are typically digital images overlaid on a digital document, as illustrated below in FIGS. 20A-20C.

A determination is then made as to whether the digital watermark is present within the image (step 1904). If the digital watermark is present, then the digital watermark is retrieved for the issuing bank (step 1906). The issuing bank is the bank identified in step 1900. Next, the digital watermark from the check is compared to the digital watermark from the issuing bank (step 1908). This comparison is made by comparing the data representing the digital watermark from the check with the data representing the digital watermark for the bank.

Then, a determination is made as to whether there is a match between the digital watermarks (step 1910). If a match is present, the check is identified as authenticated (step 1912) with the process terminating thereafter. Otherwise, the check is identified as unauthenticated (step 1914) a the process terminates. Turning back to step 1904, if no watermark is present, the process proceeds to step 1914 as described above.

With reference now to FIGS. 20A-20C, diagrams illustrating a digital watermark are depicted in accordance with a preferred embodiments of the present invention. In FIG. 20A, image 2000 is an example of a digital image without a watermark. Image 2000 contains a value for pixels, which may be obtained from scanning an image of a check. In FIG. 20B, watermark 2002 is an example of a watermark for an institution. Watermark 2002 is an image described by data, such as pixel values. This image also may be obtained from scanning a check or may be added by the institution. In FIG. 20C, image 2004 is an example of image 2000 containing watermark 2002.

Referring now to FIG. 21, a flowchart of a process used for providing a user identification document is depicted in accordance with a preferred embodiment of the present invention. The process illustrated in FIG. 21, may be implemented in a program, such as ATM transaction application 1110 in FIG. 11.

The process begins by initiating the verification of user (step 2100). The verification may be performed using numerous different processes depending on the implementation. For example, the user may insert a bank card or smart card and enter the appropriate password or PIN. Further, depending on the particular ATM, biometrics, such as matching an image of the user to a stored image or matching fingerprints, may be employed to verify the identity of the user requesting an identification document.

Next a determination is made as to whether a user has been verified (step 2102). If the user is verified, user information is then requested for an identification document from a database (step 2104). Other information, such as height, eye color, hair color, date of birth, and home address may be obtained for use in creating the identification document. This database may be located at the financial institution offering the service or from some other trusted third party.

Then, the image of the user is captured (step 2106), and an identification document is generated from the user information and image (step 2108). The identification document is printed (step 2110). The printed identification document is sent to an output bin, such as cash dispenser slot 508 in FIG. 5 (step 2112) with the process terminating thereafter. Turning back to step 2102, if the user is not verified, an error message is display (step 2114) and the process terminates.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

claims: What is claimed is:

1. A method in an automatic teller machine for processing checks, the method comprising:
receiving a customer check issued by a customer at the automatic teller machine;
identifying an amount for the customer check; and
creating a new check for the amount, wherein the funds for the amount are guaranteed by a financial institution.

2. The method of claim 1 further comprising:
verifying funds are available in an account for the customer prior to creating the new check.

3. The method of claim 1 further comprising:
dispensing the new check to the customer.

4. The method of claim 1, wherein the new check is a cashiers check.

5. The method of claim 1 further comprising:
sending the new check to a third party designated by the customer.

6. The method of claim 5, wherein the new check is sent to the third party as an electronic check.

7. A method in an automatic teller machine for processing checks, the method comprising:
receiving a check from a customer at the automatic teller machine;
scanning the check to create an image of the check;
searching the image of the check for a digital watermark;
responsive to identifying the digital watermark in the image, determining whether the digital watermark is authentic; and
responsive to the digital watermark being authentic, providing financial services to the customer.

8. The method of claim 7, wherein the determining step comprises:
identifying a financial institution for an account on which the check is issued; and
comparing the digital watermark identified in the image to a watermark associated with the financial institution to see if a match occurs, wherein the watermark is authentic if the match occurs.

9. The method of claim 7, wherein the step of providing financial services comprises:
determining whether funds are available in an account from which the check was issued to cover an amount of the check.

10. The method of claim 9, wherein the step of providing financial services further comprises:
initiating a funds transfer for the amount of the check in response to a determination that funds are available to cover the amount of the check.

11. A method in an automatic teller machine for issuing an identification card, the method comprising:
receiving a request from a user at the automatic teller machine to issue the identification card;
verifying an identification of the user;
responsive to the identification of the user being verified, capturing an image of the user;
retrieving user information associated with the user for use in generating the identification card; and
generating the identification card using the image and the user information.

12. The method of claim 11 further comprising:
dispensing the identification card to the user.

13. A data processing system in an automatic teller machine for processing checks, the data processing system comprising:
receiving means for receiving a customer check issued by a customer at the automatic teller machine;
identifying means for identifying an amount for the customer check; and
creating means for creating a new check for the amount, wherein the funds for the amount are guaranteed by a financial institution.

14. The data processing system of claim 13 further comprising:
verifying means for verifying funds are available in an account for the customer prior to creating the new check.

15. The data processing system of claim 13 further comprising:
dispensing means for dispensing the new check to the customer.

16. The data processing system of claim 13, wherein the new check is a cashiers check.

17. The data processing system of claim 13 further comprising:
sending means for sending the new check to a third party designated by the customer.

18. The data processing system of claim 17, wherein the new check is sent to the third party as an electronic check.

19. A data processing system in an automatic teller machine for processing checks, the data processing system comprising:
receiving means for receiving a check from a customer at the automatic teller machine;
scanning means for scanning the check to create an image of the check;
searching means for searching the image of the check for a digital watermark;
identifying means, responsive to identifying the digital watermark in the image, for determining whether the digital watermark is authentic; and
providing means, responsive to the digital watermark being authentic, for providing financial services to the customer.

20. The data processing system of claim 19, wherein the determining step comprises:
identifying means for identifying a financial institution for an account on which the check is issued; and
comparing means for comparing the digital watermark identified in the image to a watermark associated with the financial institution to see if a match occurs, wherein the watermark is authentic if the match occurs.

21. The data processing system of claim 19, wherein the step of providing financial services comprises:
determining means for determining whether funds are available in an account from which the check was issued to cover an amount of the check.

22. The data processing system of claim 21, wherein the step of providing financial services further comprises:
initiating means for initiating a funds transfer for the amount of the check in response to a determination that funds are available to cover the amount of the check.

23. A data processing system in an automatic teller machine for issuing an identification card, the method comprising:
receiving means for receiving a request from a user at the automatic teller machine to issue the identification card;
verifying means for verifying an identification of the user;
capturing means, responsive to the identification of the user being verified, for capturing an image of the user; and
retrieving means for retrieving user information associated with the user for use in generating the identification card;
generating means for generating the identification card using the image and the user information.

24. The data processing system of claim 23 further comprising:
dispensing means for dispensing the identification card to the user.

25. A data processing system in an automatic teller machine for processing checks, the data processing system comprising:
a bus system;
a communications unit connected to the bus system;
a memory connected to the bus system, wherein the memory includes as set of instructions; and
a processing unit connected to the bus system, wherein the processing unit executes the set of instructions to receive a customer check issued by a customer at the automatic teller machine, identify an amount for the customer check, and create a new check for the amount, wherein the funds for the amount are guaranteed by a financial institution.

26. The data processing system of claim 25, wherein the processing unit further executes the set of instructions to verify funds are available in an account for the customer prior to creating the new check.

27. The data processing system of claim 25, wherein the processing unit further executes the set of instructions to dispense the new check to the customer.

28. The data processing system of claim 25, wherein the new check is a cashiers check.

29. The data processing system of claim 25 wherein the processing unit further executes the set of instructions to send the new check to a third party designated by the customer.

30. The data processing system of claim 29, wherein the new check is sent to the third party as an electronic check.

31. A data processing system in an automatic teller machine for processing checks, the data processing system comprising:
a bus system;
a communications unit connected to the bus system;
a memory connected to the bus system, wherein the memory includes as set of instructions; and
a processing unit connected to the bus system, wherein the processing unit executes the set of instructions to receive a check from a customer at the automatic teller machine; scan the image of the check for a digital watermark; determine whether the digital watermark is authentic in response to identifying the digital watermark in the image; and provide financial services to the customer in response to the digital watermark being authentic.

32. The data processing system of claim 31, wherein the processing unit executes the set of instructions to determine by:
identifying a financial institution for an account on which the check is issued; and
comparing the digital watermark identified in the image to a watermark associated with the financial institution to see if a match occurs, wherein the watermark is authentic if the match occurs.

33. The data processing system of claim 31, wherein the processing unit executes the set of instructions to provide by determining whether funds are available in an account from which the check was issued to cover an amount of the check.

34. The data processing system of claim 33, wherein the processing unit executes the set of instructions to provide by initiating a funds transfer for the amount of the check in response to a determination that funds are available to cover the amount of the check.

35. A data processing system in an automatic teller machine for issuing an identification card, the data processing system comprising:
a bus system;
a communications unit connected to the bus system;
a memory connected to the bus system, wherein the memory includes as set of instructions; and
a processing unit connected to the bus system, wherein the processing unit executes the set of instructions to receive a request from a user at the automatic teller machine to issue the identification card; verify an identification of the user; capture an image of the user in response to the identification of the user being verified; retrieve user information associated with the user for use in generating the identification card; and generate the identification card using the image and the user information.

36. The data processing system of claim 35, wherein the processing unit further executes the set of instructions to dispense the identification card to the user.

37. A computer program product in a computer readable medium for processing checks, the computer program product comprising:
first instructions for receiving a customer check issued by a customer at the automatic teller machine;
second instructions for identifying an amount for the customer check; and
third instructions for creating a new check for the amount, wherein the funds for the amount are guaranteed by a financial institution.

38. The computer program product of claim 37 further comprising:
fourth instructions for verifying funds are available in an account for the customer prior to creating the new check.

39. The computer program product of claim 37 further comprising:
fourth instructions for dispensing the new check to the customer.

40. The computer program product of claim 37, wherein the new check is a cashiers check.

41. The computer program product of claim 37 further comprising:
fourth instructions for sending the new check to a third party designated by the customer.

42. The computer program product of claim 41, wherein the new check is sent to the third party as an electronic check.

43. A computer program product in a computer readable medium for processing checks, the computer program product comprising:
first instructions for receiving a check from a customer at the automatic teller machine;
second instructions for scanning the check to create an image of the check;
third instructions for searching the image of the check for a digital watermark;
fourth instructions, responsive to identifying the digital watermark in the image, for determining whether the digital watermark is authentic; and
fifth instructions, responsive to the digital watermark being authentic, for providing financial services to the customer.

44. The computer program product of claim 43, wherein the fourth instructions comprises:
first sub-instructions for identifying a financial institution for an account on which the check is issued;
second sub-instructions for comparing the digital watermark identified in the image to a watermark associated with the financial institution to see if a match occurs, wherein the watermark is authentic if the match occurs.

45. The computer program product of claim 43, wherein the fifth instructions comprises:
first sub-instructions for determining whether funds are available in an account from which the check was issued to cover an amount of the check.

46. The computer program product of claim 45, wherein the fifth instructions comprises:
second sub-instructions for initiating a funds transfer for the amount of the check in response to a determination that funds are available to cover the amount of the check.

47. A computer program product in a computer readable medium for issuing an identification card, the computer program product comprising:
first instructions for receiving a request from a user at the automatic teller machine to issue the identification card;
second instructions for verifying an identification of the user;
third instructions, responsive to the identification of the user being verified, capturing an image of the user;
fourth instructions for retrieving user information associated with the user for use in generating the identification card;
fifth instructions for generating the identification card using the image and the user information.

48. The computer program product of claim 47 further comprising:
fifth instructions for dispensing the identification card to the user.
